(19) United States
(12) Patent Application Publication
(10) Pub. No.: US 2003/0232186 A1
(43) Pub. Date: Dec. 18, 2003

(54) Photocatalyst coating

(75) Inventors: Ryoutarou Matsuda, Kanagawa-ken (JP); Akiko Saitou, Kanagawa-ken (JP); Kazunari Otsuka, Kanagawa-ken (JP); Ariyoshi Ishizaki, Kanagawa-ken (JP); Satoshi Uchiyama, Kanagawa-ken (JP)

Correspondence Address: PILLSBURY WINTHROP, LLP, P.O. BOX 10500, MCLEAN, VA, 22102, US

(73) Assignee: Toshiba Lighting & Technology Corporation, Tokyo (JP)

(21) Appl. No.: 10/459,543

(22) Filed: Jun. 12, 2003

(30) Foreign Application Priority Data
Jun. 12, 2002 (JP) P2002-171551
Mar. 24, 2003 (JP) P2003-081507

(51) Int. Cl. B32B 5/16; B32B 9/00

(52) U.S. Cl. 428/325; 428/336; 428/472; 428/402

(57) ABSTRACT

The invention provides a photocatalyst coating comprising a mixture of ultraviolet rays type photocatalyst fine particles and a visible rays type photocatalyst fine particles at a mass-% in a range of 3:7 to 7:3.

### CROSS-REFERENCE TO RELATED APPLICATIONS

This application is based upon and claims the benefit of priority from the prior Japanese Patent Applications JP2002-171511 filed on Jun. 12, 2002 and JP2003-81507 filed on Mar. 24, 2008, the entire contents of which are incorporated herein by reference.

### FIELD OF THE INVENTION

This invention relates to a photocatalyst coating activated by irradiating visible rays and ultraviolet rays.

### BACKGROUND OF THE INVENTION

It is known to apply a photocatalyst coating to a fluorescent lamp (see, for example, JP10-072241-A).

Conventionally, such a photocatalyst coating used for fluorescent lamps is comprised of photocatalyst which exhibits a gas decomposition activity under ultraviolet rays. Hereinafter, this sort of photocatalyst will be referred to as “ultraviolet rays type photocatalyst”. For the ultraviolet rays type photocatalyst, an anatase type titanium dioxide is in practical use.

However, a fluorescent lamp provided with conventional photocatalyst coatings using ultraviolet rays type photocatalyst fails to exhibits a sufficiently favorable gas decomposition activity. This is because that an amount of ultraviolet rays effective to activating the photocatalyst coating is very small among the light emitted from a fluorescent lamp, and that it is not able to effectively use the light emitted from the fluorescent lamp for activating the photocatalyst coating.

Recently, another kind of photocatalyst which exhibits a gas decomposition activity under visible rays has been developed (see, for example, JP11-047611-A). Hereinafter, this sort of photocatalyst will be referred to as “visible rays type photocatalyst”. For the visible rays type photocatalyst, a rutile type titanium dioxide is in practical use. There is also known a photocatalyst coating in which ultrafine metal particles comprising at least one selected from a group of Pt, Au, Pd, Rh, and Ag are adhered on the visible rays type photocatalyst fine particles which are advantageously made of the rutile type titanium dioxide. As the visible rays type photocatalyst, there is also known a type of titanium dioxide with lattice defects. Further, there is known a photocatalyst coating in which the rutile type titanium dioxide and the anatase type titanium dioxide are mixed eutectic into a continuous thin solid solution film by using a high frequency sputtering (see, for example, JP2001-062810-A).

It is expected that the photocatalyst coating using the visible rays type photocatalyst exhibits a favorable gas decomposition activity in the usage of lighting products, such as fluorescent lamps.

Then, the inventors have attempted to apply a photocatalyst coating using the visible rays type photocatalyst on a fluorescent lamp. However, it does not deliver the expected results. It is supposed that following phenomena occur at the time of developing the photocatalyst coating. That is, in heating the visible rays type photocatalyst for imparting thereto a decomposition activity under visible rays, the particle size tends to increase, and there occurs a phenomenon that the specific surface area of the photocatalyst coating decreases. Photocatalyst coatings can exhibit a higher gas decomposition activity by contacting at a greater surface with substances to be decomposed. However, when the specific surface area (BET method) of a photocatalyst coating decreases, the gas decomposition activity lowers proportionally.

### SUMMARY OF THE INVENTION

This invention aims at offering the photocatalyst coating suitable for the light containing the ultraviolet rays and visible rays from a fluorescent lamp, sunlight, etc. which exhibits favorable gas decomposition activity.

An ultraviolet rays type photocatalyst fine particles and the visible rays type photocatalyst fine particles are mixed in the mass ratio 3:7 to 7:3, and a photocatalyst coating of the 1st mode of the present invention is constituted.

In this aspect of the invention and other aspects of the invention as described later, some definitions and their technical meanings are presented for following specific terms, unless otherwise specified.

<Photocatalyst Coating>

A photocatalyst coating means a coating which is capable of being supported on a substrate and exhibits a photocatalitic activity of antifouling, defogging, deodorizing, sterilizing, decompositve-purifying for environmental contaminants, etc. The substrate for supporting the photocatalyst coating may be a body having surfaces, such as platy bodice, spherical bodice, linear bodies, fibrous bodies, and so forth. Therefore, the substrate may be solid substances. For example, glasses, ceramics, ceramics, metals are advantageous examples for the substrate. The ultraviolet rays type photocatalyst fine particles and the visible rays type photocatalyst fine particles principally constituting the photocatalyst coating may be made of alkoxide etc. in part, and take a dense structure in total. Here, the term “principally” means that the photocatalyst fine particles occupy normally 50% or more, preferably 80% or more, and optimally 95% or more of the entire mass of the photocatalyst coating. Here it is to be understood that the photocatalyst coating may be entirely made of photocatalyst fine particles. The ultraviolet rays type photocatalyst fine particles are activated by ultraviolet rays with a wavelength of about 380 nm or loss. The visible rays type photocatalyst fine particles are activated by visible rayss with a wavelength roughly no shorter than 400 nm, and ultraviolet rays with a wavelength roughly shorter than or equal to about 380 nm. A photocatalyst is comprised of a metal oxide which has a photocatalitic activity. As such a metal oxide, there are TiO₂, WO₃, CdO₃, In₂O₃, Ag₂O, MnO₂ and Cu₂O₃, Fe₂O₃, V₂O₅, ZrO₂, RuO₂ and Cr₂O₃, CoO₃, NiO, SnO₂, CeO₂ and Nh₂O₃, KTₐO₃ and SrTiO₃, K₄NbO₁₇, etc. From a viewpoint of concentrations of derived electrons and holes, concentrations of super oxide anions and hydroxyl radicals, and corrosion resistances, safeties regarding the material qualities of the super oxide anions and hydroxyl radicals, TiO₂, SrTiO₃, and K₄NbO₁₇ are preferable for the photocatalyst. In more specific, titanium dioxide (TiO₂) is optimum among them, since it is most excellent in photocatalitic activity, industrially available in ease, inexpensive, and chemically stable.

There are two types, i.e., an anatase type and a rutile type in the titanium dioxide due to a difference in the crystal structure. Anataze type titanium dioxide has a band-gap energy of 3.20 e-V, which corresponds to a wavelength of 388 nm. As seen from the above, anatase type titanium dioxide is suitable for photocatalyst capable of activating under ultraviolet rays with a wavelength of 380 nm or less.

This ultraviolet rays type photocatalyst can be made into particles with a relatively small size. For example, the mean particle size is desirable to be normally 20 nm or less, or preferably 10 nm or less, but not be below a lower limit of 5 nm. The lower limit is given by considering the ease of industrial manufacturing the ultraviolet rays type photocatalyst fine particles. The photocatalyst coating using the ultraviolet rays type photocatalyst fine particles as the photocatalyst and containing 0.1 to 5.0 mass-% of silica based binder is desirable to have a specific surface area (BET method) of normally around 40 m²/g or more, preferably around 100 m²/g or more, and optimally ground 120 m²/g or more. Considering the ease of industrial manufacturing, the upper limit of the specific surface area (BET method) is roughly around 300 m²/g at a highest difficulty, roughly around 250 m²/g at a highish difficulty and roughly around 200 m²/g in an adequate difficulty.

The ultraviolet rays type photocatalyst is desirable to be principally made of an anatase type and/or a brookite type titanium dioxide. Further, the ultraviolet rays type photocatalyst can comprised of only titanium-dioxide particles, or the titanium-dioxide particles as well as ultrafine metal particles and/or ultrafine oxide particles adhered thereto. The metal substance for constituting the adhering ultrafine particles can be one or more selected from a group of platinum, gold, chromium, manganese, vanadium, nickel, and palladium. The oxide substance for constituting the adhering ultrafine particles can be one or more selected from a group of vanadium oxide, molybdenum oxide, ferrous oxide, niobium oxide, tin oxide, a zinc oxide, chromic oxide, tungsten oxide, and ITO (Indium Tin Oxide).

In the visible rays type photocatalyst used for the photocatalyst coating of the present invention, their particles can be adhered thereon with ultrafine metal particles and/or ultrafine oxide particles. The visible rays type photocatalyst can also be made from a rutile type titanium dioxide. Although the rutile type titanium dioxide solid is inexpensive in compared with the anatase type titanium dioxide, it was not notable for the photocatalyst coating because of it being weak in photocatalytic activity. However, it is found that the photocatalytic activity of the rutile type titanium dioxide fine particles becomes significant by adhering thereon with ultrafine metal and/or oxide particles. The band gap energy of the rutile type titanium dioxide is 3.05 e-V, and when this is converted into wavelength, it is equivalent to 407 nm. Therefore, a rutile type titanium dioxide is suitable for the visible rays type photocatalyst activated with visible rays and ultraviolet rays of wavelengths roughly no shorter than 400 nm. The visible rays type photocatalyst fine particles used for a photocatalyst coating of the present invention is activated by visible rays with wavelengths roughly no shorter than 400 nm, and ultraviolet rays with wavelengths of roughly shorter than or equal to about 380 nm. By the way, it is desirable that the visible rays have wavelengths preferably longer than or equal to 410 nm. It is also desirable that the ultraviolet rays have wavelengths within a range of preferably 300 to 380 nm.

The visible rays type photocatalyst fine particles are used with relatively large particle size for the photocatalyst coating of the present invention. For example, the visible rays type photocatalyst fine particles are used with a mean particle size of normally 10 to 1000 nm, or preferably 30 to 500 nm. The photocatalyst coating using the visible rays type photocatalyst fine particles as the photocatalyst and containing 0.1 to 5.0 mass-% of silica based binder is desirable to have a specific surface area (BET method) of roughly 15 m²/g or more, or preferably 30 m²/g or more. Considering the ease of industrial manufacturing, the upper limit of the specific surface area (BET method) is roughly around 100 m²/g at a highest difficulty, roughly around 75 m²/g at a highish difficulty and roughly around 50 m²/g in an adequate difficulty. By the way, in the present invention, letting the photocatalyst coating exhibit the photocatalitic activity more effectively, the visible rays type photocatalyst fine particles and the ultraviolet rays type photocatalyst fine particles are used by being mixed together. It is necessary to use visible rays type photocatalyst fine particles having a particle size larger than that of the ultraviolet rays type photocatalyst fine particles. In other words, it is necessary to use a photocatalyst coating with a smaller specific surface area, when expressing by a BET method.

Moreover, the visible rays type photocatalyst preferably contains a rutile type and/or a substituted nitrogen-containing anatase type titanium-dioxide particles with mean particle size of preferably 10 to 100 m in major proportions, and the particles are adhered with ultrafine metal and/or oxide particles. The metal substance for constituting the adhering ultrafine particles can be one or more selected from a group of platinum, gold, chromium, manganese, vanadium, nickel, and palladium. The oxide substance for constituting the adhering ultrafine particles can be one or more selected from a group of vanadium oxide, molybdenum oxide, ferrous oxide, niobium oxide, tin oxide, a zinc oxide, chromic oxide, tungsten oxide, and ITO (Indium Tin Oxide).

It is desirable that the visible rays typo photocatalyst fine particles and the ultraviolet rays type photocatalyst fine particles are mixed in the mass ratio 3:7 to 7:3. If it is the rate, high gas decomposition activity will be obtained under visible rays and ultraviolet rays which are irradiated, for example from illuminators, such as a fluorescent lamp. In other words, when the visible rays type photocatalyst fine particles and the ultraviolet rays type photocatalyst fine particles are mixed at a ratio out of the range of 3:7 to 7:3, this sort of photocatalyst coating fails to have a practically sufficient gas decomposition activity. This is because the whole specific surface area (BET method) of the photocatalyst coating decreases, as the quantity of the visible rays typo photocatalyst fine particles increases over the mixing ratio of 3:7. Although a photocatalitic activity of the visible rays type photocatalyst fine particles and the ultraviolet rays type photocatalyst fine particles works in multiplication by a photocatalyst coating of this mode, it is because such synergism will become weak if that quantity difference becomes large. If a quantity of the ultraviolet rays type photocatalyst fine particles becomes 70% or more, photocatalyst activity by ultraviolet rays will become dominant, and it will be thought that it is because it becomes impossible to absorb visible rays effectively. Ranges of a desirable mixing ratio of the ultraviolet rays type visible photocatalyst fine particles from which gas decomposition activity high in comparison is obtained, and the visible rays type photocatalyst fine particles are 4:6-6:4. Optimal mixing ratio of the ultraviolet rays type visible photocatalyst fine particles from which still higher gas decomposition activity is obtained, and the visible rays type photocatalyst fine particles is about 5:5. Desirable specific surface area (BET method) of a photocatalyst coating of the present invention is the range of 20 to 65 m²/g, and optimal specific surface area (BET method) is the range of 25 to 60 m²/g.

In order to bind the ultraviolet rays type visible photocatalyst fine particles and the visible rays type photocatalyst fine particles together to raise the mechanical strength of a photocatalyst coating, it is preferred that proper quantity mixture of the suitable binder is carried out. As a binder, kinds, such as silicone, and SiO₂, ZrO₂, Al₂O₃, or two or more sorts can be used, for example. These substances can effectively bind the ultraviolet rays type visible photocatalyst fine particles and the visible rays type photocatalyst fine particles together. Since transmission of ultraviolet rays and visible rays is high, they do not diminish gas decomposition activity of a photocatalyst coating. 1-30% of range is a proper quantity in a mass-% to the whole quantity of the ultraviolet rays type photocatalyst fine particles and the visible rays type photocatalyst fine particles, and, as for a mixing ratio of a binder, it is desirable that it is 7-15% of range much more suitably. If there is too much quantity of binder, photocatalyst fine particles will be buried into the binder so that they will become difficult to exhibit a photocatalitic activity. If the quantity of the binder is too small, necessary binding capacity will no longer be obtained. A binder can bind between fine photocatalyst fine particles and between a photocatalyst coating and bases by carrying out fusion solidification. A binder takes an ultrafine particle-like form, and it can bind between fine photocatalyst fine particles with the Van der Waals interaction, or bind the photocatalyst itself to the substrate.

By mixing a binder as mentioned above, a photocatalyst coating of the present invention can have strong mechanical strength, maintaining strong gas decomposition activity in the range of 150 to 1000 nm of coating thickness. Photocatalyst coatings are methods, such as various known methods for coating deposition, for example, a spray method, a dip method, the brush applying method, or an electrostatic adsorption process, and can be made to put on a base by normal temperature, low-temperature heating, or high temperature heating calcination.

The substrate should just be the thing of a suitable form for a photocatalyst coating to exhibit a photocatalitic activity. As such a base, although building materials, such as electric products, such as for example, a lighting product, a windowpane, a window frame, and a tile, a deodorization machine, a health product, vehicles, furniture, etc. are mentioned, it is not limited to these. The term “lighting product” is a term including a light source, a luminaire to which the light source is equipped, and a component constituting the luminaire. As a light source, there are a fluorescent lamp, a high-pressure discharge lamp, a tungsten halogen lamp, etc., for example. As a luminaire, there are an indoor type lighting equipment, an outdoor type lighting equipment, a beacon equipment, an indicating-lamp equipment, a signboard lighting equipment, etc. As a component constituting the luminaire, there are a shade, a glove, a floodlighting aperture, a reflecting plate, etc. A photocatalyst coating of the present invention is supported in general on a base, such as a lighting product which is located in a position where light from a light source is irradiated.

As for a photocatalyst coating of the present invention, since the visible rays type photocatalyst fine particles is activated by visible rays generated from a light source for lighting etc. while the ultraviolet rays type photocatalyst fine particles and the visible rays type photocatalyst fine particles are activated by ultraviolet rays, gas decomposition activity becomes still stronger when each photocatalyst fine particles does a photocatalitic activity so in multiplication.

Next, the conventional photocatalyst coating (conventional example 1) which used only the ultraviolet rays type photocatalyst fine particles for comparison, the conventional photocatalyst coating (conventional example 2) only using the visible rays type photocatalyst fine particles, and a photocatalyst coating (this example of invention) of the present invention are formed in a test piece of the same specification, and a result of having measured a photocatalitic activity of each test piece is explained. Decomposition activity of ethanol gas when carrying out optical irradiation is measured to each above-mentioned test piece using a fluorescent lamp provided with a three-band emission fluorescent substance for general illuminations. Consequently, the size relations of those gas decomposition activities were as follows.

“example of invention”>“conventional example 2”>“conventional example 1”

As for “this example of invention”, 4 to 5 times as much gas decomposition activity as “the conventional example 1” is obtained. As a result of dominant wavelength's conducting the same experiment using a black light lamp which is 360 nm, the size relations of the gas decomposition activities were as follows.

“conventional example 1”>“this example of invention”>“conventional example 2”

The above relation should represent that the photocatalyst coating of the present invention has a high gas decomposition activity, even if spectral distribution of a light source for lighting changes. Sufficiently high gas decomposition activity is accepted under sunlight irradiation as well as the above.

In the photocatalyst coating of the present invention, the ultraviolet rays type photocatalyst fine particles are able to have a specific surface area (BET method) of 50 to 400 m²/g, while the visible rays type photocatalyst fine particles are able to have a specific surface area (BET method) of 30 to 200 m²/g.

This specific surface area (BET method) is the value which measured by the BET method and is acquired. In a photocatalyst coating of this mode, it is preferred that specific surface area (BET method) of the ultraviolet rays type photocatalyst fine particles is the range which is 100 to 200 m²/g in the range whose specific surface area (BET method) of the visible rays type photocatalyst fine particles is 50 to 80 m²/g. That is, in order for a photocatalyst coating to exhibit a photocatalitic activity effectively, it is required for a mean particle size of the ultraviolet rays type photocatalyst fine particles to be smaller than a mean particle size of the visible rays type photocatalyst fine particles. If this is expressed with a BET value, it is required for a BET value of the ultraviolet rays type photocatalyst fine particles to be larger than a BET value of the visible rays type photocatalyst fine particles.

As the photocatalyst coating is provided with the above construction, the specific surface area (BET method) of the whole photocatalyst coating is larger than that of the conventional photocatalyst coating comprising only the ultraviolet rays type photocatalyst fine particles. Therefore, gas decomposition activity becomes strong from a photocatalyst coating which comprises only a photocatalyst coating and the visible rays type photocatalyst fine particles to which a photocatalyst coating of the present invention changes only from the ultraviolet rays type photocatalyst fine particles.

A photocatalyst coating of the present invention not only decomposes harmful gas, but has an effect to antifouling. Especially, since the photocatalyst coating has a highly smooth surface, there is an effect that the photocatalyst coating is hardly adhered with soil particles and thus able to contribute for antifouling.

In the photocatalyst coating, the ultraviolet rays type photocatalyst fine particles may be comprised of an anatase type titanium dioxide with mean particle size of 5 to 20 nm and/or a brookite type titanium dioxide as a major component. The photocatalyst coating may be a kind as which metal and/or oxide were installed by the titanium dioxide at the ultraviolet rays type photocatalyst fine particles, and installation metal is chosen from a group of platinum, gold, chromium, manganese, vanadium, nickel, and palladium again, or two or more sorts, and can be a kind as which installation oxide is chosen from vanadium oxide, molybdenum oxide, ferrous oxide, niobium oxide, tin oxide, a zinc oxide, chromic oxide, tungsten oxide, and a group of ITO, or two or more sorts.

The photocatalyst coating may comprise a kind chosen from a group of silicone, and SiO₂, ZrO and Al₂O₃ as a binder, or two or more sorts again, and can contain a substance with high transmission of visible rays and ultraviolet rays.

In the photocatalyst coating, a binder may be included at a 1 to 30% to the quantity of the ultraviolet rays type photocatalyst fine particles and the visible rays type photocatalyst fine particles.

By being formed in a fluorescent lamp, the photocatalyst coating may bear a high mechanical strength, and may exhibit a favorable photocatalitic activity. The photocatalyst coating may be formed in a thickness in a range of 150 to 1000 nm.

Additional objects and advantages of the present invention will be apparent to persons skilled in the art from a study of the following description and the accompanying drawings, which are hereby incorporated in and constitute a part of this specification.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic section showing an embodiment of the photocatalyst coating according to the present invention;

FIG. 2 is a partial enlarged cutaway perspective front elevation showing a fluorescent lamp provided with the photocatalyst coating according to the present invention;

FIG. 3 is a graph showing a spectral distribution characteristics of a fluorescent lamp provided with the photocatalyst coating according to the present invention in a range of wavelength from 300 to 800 nm in comparison with a fluorescent lamp not provided with such a photocatalyst coating;

FIG. 4 is an enlarged drawing showing a portion of FIG. 3 in a range of wavelength from 300 to 400 nm;

FIG. 5 is a graph showing a formaldehyde gas decomposition activity of an embodiment of the photocatalyst coating according to the present invention applied on a fluorescent lamp according to the change of a mixing ratio of the visible rays type photocatalyst fine particles constituting the photocatalyst coating;

FIG. 6 is a schematic section showing a device for measuring the gas decomposition activity of a photocatalyst coating; and

FIG. 7 is the graph showing a measuring result of the gas decomposition activity of the photocatalyst coating according to the present invention applied on a fluorescent lamp, obtained by the measuring device of FIG. 6, according to the change of mixing ratio of the ultraviolet rays type photocatalyst fine particles and the visible rays type photocatalyst fine particles constituting the photocatalyst coating.

### DESCRIPTION OF THE PREFERRED EMBODIMENTS

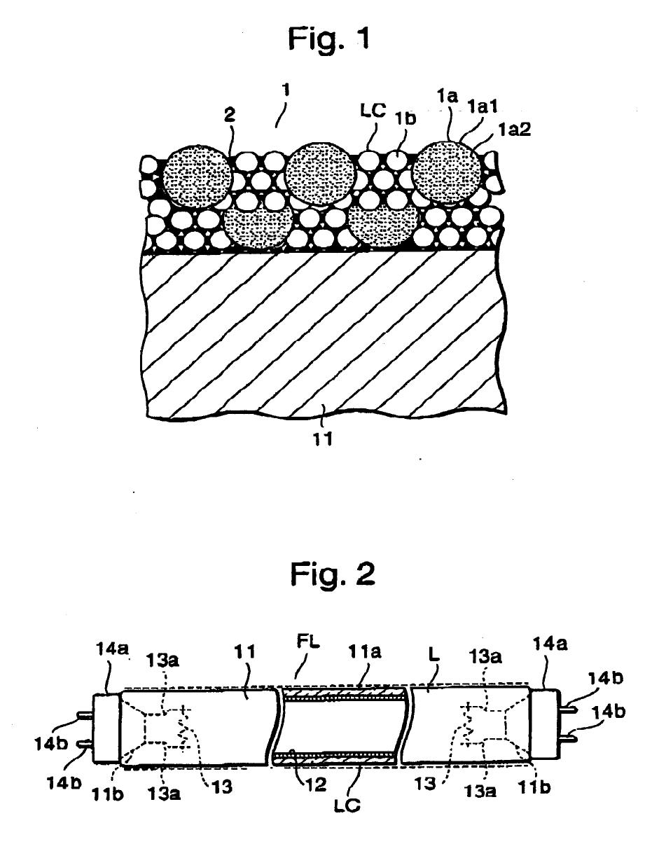

The present invention will be described in detail with reference to the FIGS. 1 through 7.

FIG. 1 schematically shows an embodiment of the photocatalyst coating according to the present invention. As shown in FIG. 1, a photocatalyst coating LC is comprised of photocatalyst 1 and binder 2. The photocatalyst coating LC is constituted by visible rays type photocatalyst fine particles 1a and ultraviolet rays type photocatalyst fine particles 1b mixed each other at a predetermined rate. Tho visible rays type photocatalyst fine particles 1a are in general activated under ultraviolet rays with a wavelength roughly shorter than or equal to about 380 nm, and visible rays with a wavelength roughly no shorter than 400 nm. The visible rays type photocatalyst fine particles 1a1 are each a rutile type titanium-dioxide fine particle 1a1 with a mean particle size of 70 nm which is adhered with about 600 pieces of platinum (Pt) ultrafine particles 1a2 with a mean particle size of 1.5 nm. On the other hand, the ultraviolet rays type photocatalyst fine particles 1b are in general activated by ultraviolet rays with a wavelength of 380 nm or less, and comprised of anatase type titanium-dioxide fine particles with a mean particle size of 20 nm. The mixing ratio of the ultraviolet rays type photocatalyst fine particles 1b and the visible rays type photocatalyst fine particles 1a is 5:5 in a mass-%.

A binder 2 is comprised of SiO₂ with a solid-solution phase, and binding particles of the visible rays type photocatalyst fine particles 1a and the ultraviolet rays type photocatalyst fine particles 1b with each other. The mixing ratio of the binder 2 to the photocatalyst 1 is about 10% in a mass-%. This photocatalyst coating LC is adhered to the outer wall of a transparent discharge envelope 11 of fluorescent lamps explained in detail later by the binder 2.

Referring now to FIG. 2, a fluorescent lamp provided with one embodiment of the photocatalyst coating according to the present invention will be explained.

As shown in FIG. 2, the fluorescent lamp L comprises a transparent discharge envelope 11, a fluorescent material coating 12, a pair of electrodes 13 and a pair bulb-bases 14. The transparent discharge envelope 11 is filled with discharge medium.

The transparent discharge envelope 11 comprises a slender long glass tube 11a and a pair of flare stems 11b. The glass tube 11a is made of soda-lime glass. Each flare stem 11b is provided with a flare, a pair of internal lead-wires, and a pair of external lead-wires. The flares are respectively provided on both sides of the glass tube 11a. The exhaust pipe had been originally formed on the flare, and used for exhausting the air in the transparent discharge envelope 11 at the time of assembling the fluorescent lamp and then introducing the discharge medium into the transparent discharge envelope 11. The exhaust pipes had been pinched off, after the discharge medium filled into the envelope 11. The pair of internal lead-wires stand erect in parallel on the flare stem 11b. The electrodes 13, 13 are each supported between both proximal ends of the internal lead-wires, 13a, 13a. The proximal end of the internal lead-wires 13a, 13a is connected to a pair of external lead-wires, respectively. The distal ends of the external lead-wires are embedded in the flare stem 11b, and the proximal ends thereof are led out of the transparent discharge envelope 11.

The fluorescent material coating 12 is comprised of a three-band emission fluorescent substance, and is formed on the inner wall of the transparent discharge envelope 11. The three-band emission fluorescent substance comprises BaMgAl₁₅O₂₇:Eu for emitting a blue ray, LaPO₄:Ce for emitting a green ray, and Y₂O₃ for emitting a red ray.

The electrode 13 is comprised of a coiled tungsten filament and an electron emitting substance coated on the coiled tungsten filament.

The discharge medium is comprised of an adequate quantity of mercury and argon of about 300 Pa.

The bulb-base 14 is comprised of bulb-base main portion 14a and a pair of pin terminals 14b and 14b, The bulb-base main portions 14a, 14a are shaped like a cap, and the both ends of the transparent discharge envelope 11 are equipped with the bulb-base main portions 14a, 14a. The pair of pin terminals 14b and 14b are mounted on the bulb-bases 14a in isolated each other, connected with external lead-wires, respectively.

The fluorescent lamp is provided with the photocatalyst coating LC according to one embodiment of the present invention, thereby interference fringes become hard to be observed.

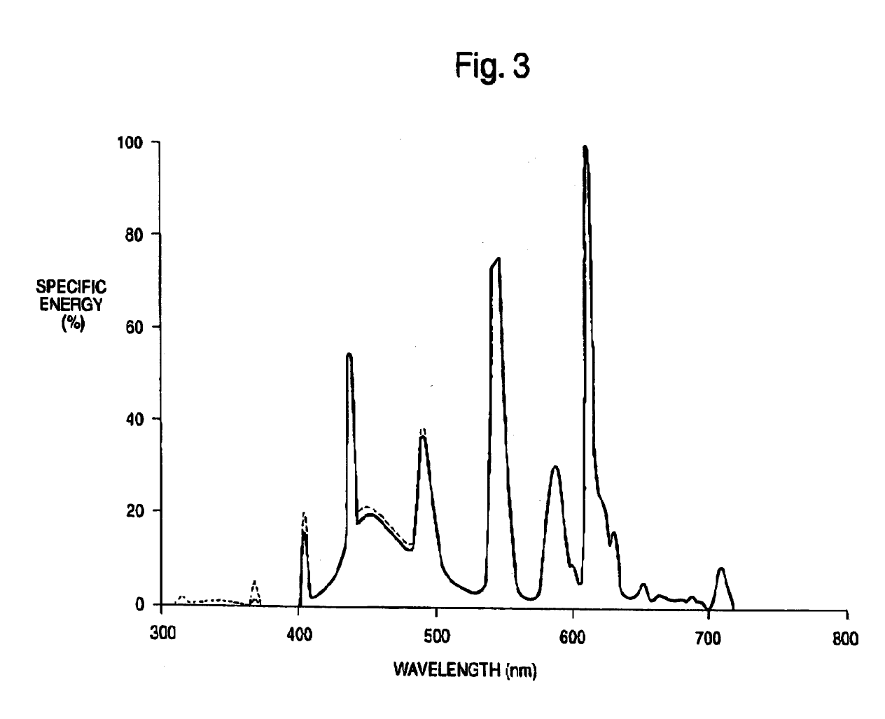

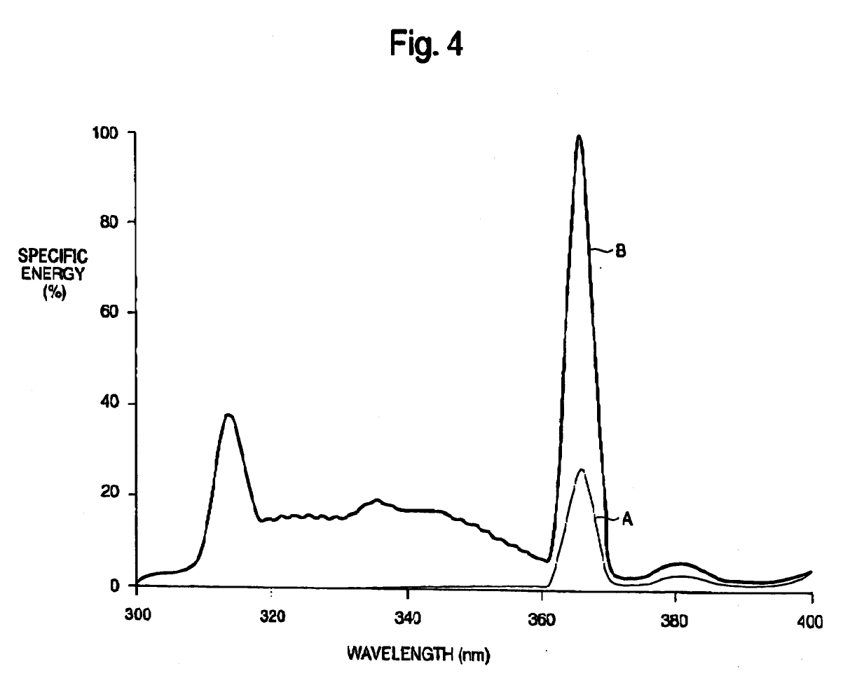

FIG. 3 shows a spectral distribution characteristics of a fluorescent lamp applied the photocatalyst coating according to the present invention in a range of wavelength from 300 to 800 nm in comparison with a fluorescent lamp not applied such a photocatalyst coating. FIG. 4 shows an enlarged portion of FIG. 3 around the range of wavelength from 300 to 400 nm. In each of FIGS. 3 and 4, the horizontal axis shows a wavelength in a unit of “nm” and the vertical axis shows a specific energy in a relative ratio “%”. Here, the fluorescent lamp applied the photocatalyst coating according to the present invention and the fluorescent lamp not applied such a photocatalyst coating have the same specification.

In FIG. 3, the solid line graph represents the spectral distribution characteristic of the photocatalyst coating according to the present invention, and the broken line graph represents the spectral distribution characteristic of the fluorescent lamp not applied such a photocatalyst coating. In FIG. 3, the broken line graph is hidden at portions where both graphs overlap, and only the solid line graph appears. As seen from FIG. 3, in the photocatalyst coating according to the present invention, a part of visible rays in the range of 400 to 500 nm in wavelength and ultraviolet rays of 380 nm or less in wavelength are absorbed with the photocatalyst coating LC. Here, a part of the ultraviolet rays and the visible rays are absorbed by the visible rays type photocatalyst fine particles 1a, and another part of the ultraviolet rays is absorbed by the ultraviolet rays type photocatalyst fine particles 1b. Moreover, from the drawings, it is also seen that the visible rays are hardly absorbed and thus the ratio of absorption amount of visible rays to the total amount of light is very low.

As shown in FIG. 4, in the range of 360 to 370 nm in wavelength the solid line graph is remarkable decreased in compared with the broken line graph. From this, it is seen that in fluorescent lamp applied with the photocatalyst coating according to the present invention the photocatalitic activity of the photocatalyst coating LC is remarkably activated under the ultraviolet rays in the range of 360 to 370 nm in wavelength, and thus the ultraviolet rays in the range is effectively absorbed so as that the ultraviolet rays in the range passing outwards decreases.

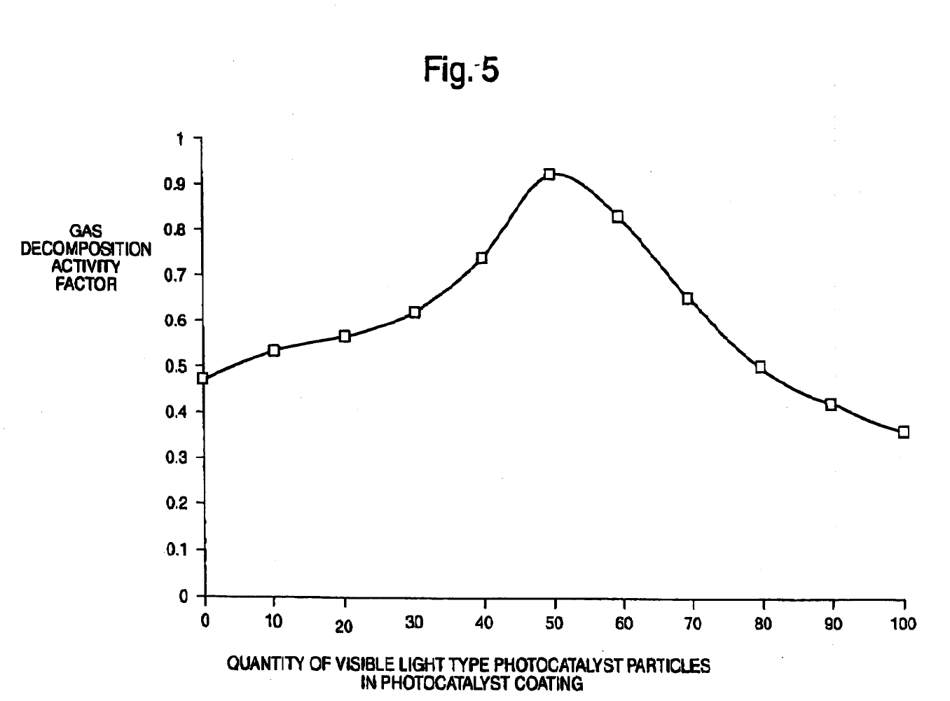

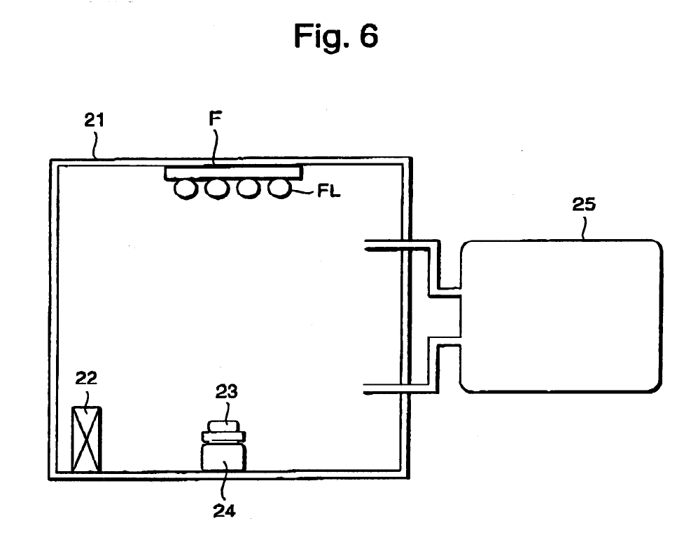

FIG. 5 shows a formaldehyde gas decomposition activity of the photocatalyst coating according to the present invention applied on a fluorescent lamp according to a change of mixing ratio of the visible rays type photocatalyst fine particles constituting the photocatalyst coating. In FIG. 5, the horizontal axis shows the mixing ratio of the visible rays type photocatalyst fine particles in a unit of “mass %”, while the vertical axis shows the gas decomposition activity factor. The gas decomposition activity factor is measured by using a measuring device as shown in FIG. 6. That is, a test piece, i.e., an alkali glass piece applied thereon the photocatalyst coating is set in a sealed box of the device. Then formaldehyde gas is introduced into the sealed box. Then the formaldehyde gas concentration is measured immediately after the gas introduction and after three hours. The gas decomposition activity factor is then found as an attenuation degree from the difference of the measured values. It is seen from FIG. 5 that the larger the gas decomposition activity factor is, the larger the gas decomposition activity factor is.

As shown in FIG. 6, the measuring device is provided with four normal 20 W type (FL20) three-band emission fluorescent lamps FL in the sealed box with an internal volume of 1 m³. The teat piece is applied light radiated from the lamps in an atmosphere of prescribed gas.

As seen from FIG. 5, the photocatalyst coating according to the present invention exhibits a maximum gas decomposition activity at the mixing ratio of about 50 mass-% of the visible rays type photocatalyst fine particles. Therefore, in the photocatalyst coating according to the present invention, it is desirable that the quantity of the visible rays type photocatalyst fine particles is in a range of normally 30 to 80 mass-%, or preferably 30 to 70 mass-%.

In the measuring device as shown in FIG. 6, a fan 22, a source of gas 23, and a heater 24 are equipped in the stainless steel-made sealed box 21. In addition, the measuring device is provided with a gas monitor 25 for monitoring the gas in the sealed box 21. The fan 22 circulates the gas in the sealed box 21. The source of gas 23 supplies formaldehyde gas. Theater 24 heats the source of gas 23 so as that formaldehyde gas is generated from the source of gas 23. The gas monitor 25 measures the formaldehyde gas concentration in the sealed box 21.

The measurement of the gas decomposition activity factor according to the measuring device is carried out in the following procedure. A test piece, i.e., an alkali glass piece applied with the photocatalyst coating according to the present invention is set in the sealing box 21. A mixture of Kr gas and N2 gas is charged in the sealed box 21. 2 ppm of formaldehyde gas is generated from the source of gas 23 by heating with the heater 24. Then, formaldehyde gas is circulated in the sealed box 21 with the fan 22. The gas in the sealed box 21 is kept circulated with the fan 22, and gas concentration is measured after three hours.

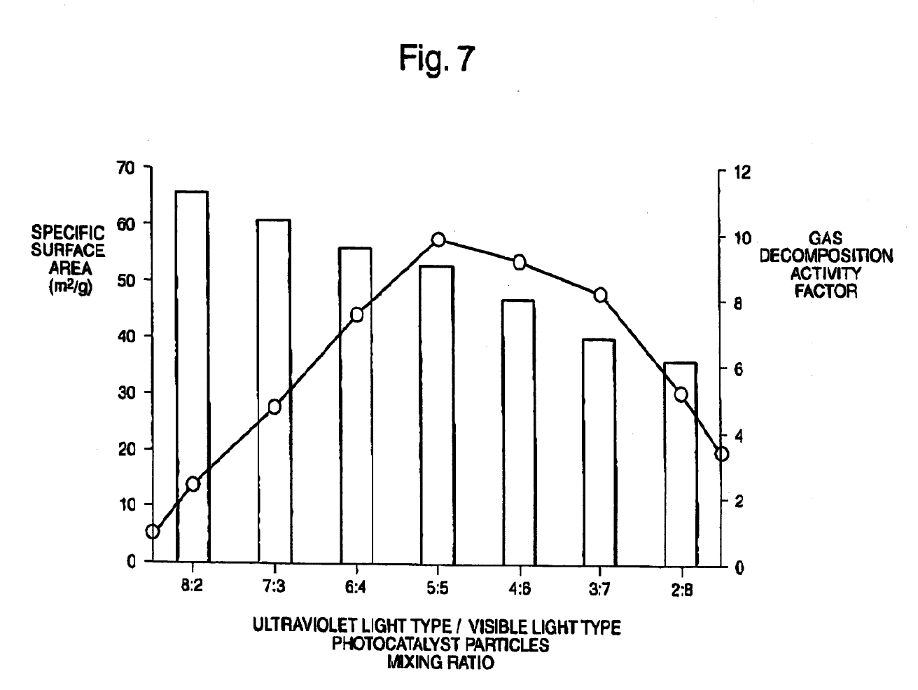

FIG. 7 shows the gas decomposition activity factor representing the attenuation degree found from the gas concentration after three hours, which is measured by the above procedure. In FIG. 7, the horizontal axis shows the mixing ratio of the ultraviolet rays type photocatalyst fine particles and the visible rays type photocatalyst fine particles constituting the photocatalyst coating. The left-side vertical axis shows the specific surface area (BET method) of the photocatalyst coating in a unit of m²/g. The right-side vertical axis shows the gas decomposition activity factor which represents the attenuation degree of the formaldehyde gas after three hours in a relative value. In FIG. 7, the bar graphs shows the specific surface area (BET method) of the photocatalyst coating in a unit of m²/g, and the line graph shows the gas decomposition activity factor.

As seen from FIG. 7, the photocatalyst coating exhibits a maximum gas decomposition activity factor in a situation that the ultraviolet rays type photocatalyst fine particles and the visible rays type photocatalyst fine particles are mixed together at a mixing ratio (mass ratio) of about 5:5. Moreover, when the mixing ratio thereof is in a range of normally 7:3 to 2:8, or preferably 7:3 to 3:7, the photocatalyst coating according to the present invention exhibits a favorable gas decomposition activity higher than that of conventional photocatalyst coating, i.e. a photocatalyst coating containing only either one of the ultraviolet rays type photocatalyst fine particles and the visible rays type photocatalyst fine particles.

As the quantity of the ultraviolet rays type photocatalyst fine particles increases, the specific surface area (BET method) becomes larger. In contrary, the quantity of the ultraviolet rays type photocatalyst fine particles decreases, the specific surface area (BET method) becomes smaller. From above, it is understood that the gas decomposition activity of the photocatalyst coating depends on the specific surface area (BET method) and that the ultraviolet rays type photocatalyst fine particles contribute to increase the specific surface area of the photocatalyst coating. However, since the photocatalyst activity under the ultraviolet rays becomes dominant and it becomes hard to effectively absorb visible rays when the quantity of the ultraviolet rays type photocatalyst fine particles becomes 70% or more, the gas decomposition activity as the whole photocatalyst coating decreases.

As described above, the present invention can provide an extremely preferable photocatalyst coating.

While there have been illustrated and described what are at present considered to be preferred embodiments of the present invention, it will be understood by those skilled in the art that various changes and modifications may be made, and equivalents may be substituted for elements thereof without departing from the true scope of the present invention. In addition, many modifications may be made to adapt a particular situation or material to the teaching of the present invention without departing from the central scope thereof. Therefore, it is intended that the present invention not be limited to the particular embodiment disclosed as the best mode contemplated for carrying out the present invention, but that the present invention includes all embodiments falling within the scope of the appended claims.

The foregoing description and the drawings are regarded by the applicant as including a variety of individually inventive concepts, some of which may lie partially or wholly outside the scope of some or all of the following claims. The fact that the applicant has chosen at the time of filing of the present application to restrict the claimed scope of protection in accordance with the following claims is not to be taken as a disclaimer or alternative inventive concepts that are included in the contents of the application and could be defined by claims differing in scope from the following claims, which different claims may be adopted subsequently during prosecution, for example, for the purposes of a divisional application.

What is claimed is:

1. A photocatalyst coating comprising a mixture of ultraviolet rays type photocatalyst fine particles and a visible rays type photocatalyst fine particles in the mass ratio 3:7 to 7:8.

2. A photocatalyst coating as claimed in claim 1, wherein the ultraviolet rays type photocatalyst fine particles have a specific surface area (BET method) of 50 to 400 m²/g, and the visible rays type photocatalyst fine particles have a specific surface area (BET method) of 30 to 200 m²/g.

3. A photocatalyst coating as claimed in claim 1, wherein the ultraviolet rays type photocatalyst fine particles are principally comprised of an anatase type titanium dioxide and/or a brookite type titanium dioxide which have mean particle size of 5 to 20 nm.

4. A photocatalyst coating as claimed in claim 3, wherein ultrafine metal particles comprising at least one selected from a group of platinum, gold, chromium, manganese, vanadium, nickel, and palladium are adhered on the ultraviolet rays type photocatalyst fine particles.

5. A photocatalyst coating as claimed in claim 3, wherein ultrafine oxide particles comprising at least one selected from a group of vanadium oxide, molybdenum oxide, ferrous oxide, niobium oxide, tin oxide, a zinc oxide, chromic oxide, tungsten oxide, and ITO are adhered on the ultraviolet rays type photocatalyst fine particles.

6. A photocatalyst coating as claimed in any one of claims 1 and 2, wherein the visible rays type photocatalyst fine particles are principally comprised of a rutile type titanium dioxide and/or a substituted nitrogen-containing anatase type titanium dioxide which have mean particle size of 10 to 100 nm, and adhered thereon with ultrafine metal particles comprising at least one selected from a group of platinum, gold, chromium, manganese, vanadium, nickel, and palladium.

7. A photocatalyst coating as claimed in any one of claims 1 and 2, wherein the visible rays type photocatalyst fine particles are principally comprised of a rutile type titanium dioxide and/or a substituted nitrogen-containing anatase type titanium dioxide which have mean particle size of 10 to 100 nm, and adhered thereon with ultrafine oxide particles comprising at least one selected from a group of vanadium oxide, molybdenum oxide, ferrous oxide, niobium oxide, tin oxide, a zinc oxide, chromic oxide, tungsten oxide, and ITO.

8. A photocatalyst coating as claimed in claim 1, further comprising a binder for binding the photocatalyst fine particles together which is comprised of at least one selected from a group of silicone, SiO₂, ZrO and Al₂O₃.

9. A photocatalyst coating as claimed in claim 7, wherein the binder is included at a mass-% of 1 to 30%.

10. A photocatalyst coating as claimed in claim 1, wherein the coating has a thickness of 150 to 1000 nm.
